(19) United States
(12) Patent Application Publication
(10) Pub. No.: US 2023/0298787 A1
(43) Pub. Date: Sep. 21, 2023

(54) SOFT MAGNETIC METAL PARTICLE, SOFT MAGNETIC METAL POWDER, MAGNETIC ELEMENT BODY, AND COIL-TYPE ELECTRONIC COMPONENT

(71) Applicant: TDK CORPORATION, Tokyo (JP)

(72) Inventors: Yu SAKURAI, Tokyo (JP); Hidenobu Umeda, Tokyo (JP); Hideyuki Itoh, Tokyo (JP); Ryuichi Wada, Tokyo (JP); Kouichi Kakuda, Tokyo (JP)

(73) Assignee: TDK CORPORATION, Tokyo (JP)

(21) Appl. No.: 18/185,101

(22) Filed: Mar. 16, 2023

(30) Foreign Application Priority Data
Mar. 17, 2022 (JP) 2022-042660

(51) Int. Cl. H01F 1/147

(52) U.S. Cl. CPC H01F 1/14733; H01F 27/28

(57) ABSTRACT

A soft magnetic metal particle comprises an Fe—Ni based soft magnetic metal. The soft magnetic metal particle includes both an fcc phase and a bcc phase. A magnetic element body includes the soft magnetic metal particle. A coil-type electronic component includes the magnetic element body and a coil conductor.

### TECHNICAL FIELD

The present invention relates to a soft magnetic metal particle, a soft magnetic metal powder, a magnetic element body, and a coil-type electronic component.

### BACKGROUND

Patent Document 1 discloses an invention relating to a multilayer inductor. A magnetic material layer of the multilayer inductor includes a magnetic material containing metal particles made from an Fe—Si-M soft magnetic alloy (M is a metal element that is more easily oxidized than Fe). Patent Document 2 discloses an invention relating to a soft magnetic alloy powder. The powder includes Fe—Ni based crystal particles containing controlled amounts of Fe, Ni, Co, and Si within specific ranges.
Patent Document 1: JP Patent Application Laid Open No. 2012-238840
Patent Document 2: JP Patent Application Laid Open No. 2008-135674

### SUMMARY

It is an object of the present invention to provide a soft magnetic metal particle capable of being manufactured into a magnetic element body having a high metal space factor and high saturation magnetization and into a coil-type electronic component having good inductance, good DC superimposition characteristics, and a good withstand voltage.

A soft magnetic metal particle according to the present invention comprises an Fe—Ni based soft magnetic metal, wherein the soft magnetic metal particle includes both an fcc phase and a bcc phase.

The soft magnetic metal particle according to the present invention may have a value of 0.01 or more and 0.80 or less as a value calculated by dividing a diffraction peak intensity of the bcc phase in an X-ray diffraction chart by a diffraction peak intensity of the fcc phase therein.

The soft magnetic metal particle according to the present invention may comprise Fe, Ni, and Co as a main component.

A soft magnetic metal powder according to the present invention comprises the above-mentioned soft magnetic metal particle.

A magnetic element body according to the present invention comprises the above-mentioned soft magnetic metal particle.

A coil-type electronic component according to the present invention comprises the above-mentioned magnetic element body and a coil conductor.

In the coil-type electronic component according to the present invention, the coil conductor may be disposed inside the magnetic element body.

In the coil-type electronic component according to the present invention, a coil inner-diameter region and a cover region of the magnetic element body may comprise the above-mentioned soft magnetic metal particle.

### BRIEF DESCRIPTION OF THE DRAWING(S)

FIG. 1 is a schematic sectional view of a multilayer inductor according to an embodiment of the present invention.

FIG. 2 is an enlarged schematic view of a main part of an atomization apparatus.

### DETAILED DESCRIPTION

Hereinafter, the present invention will be explained based on an embodiment shown in the drawings.

### Structure of Coil-Type Electronic Component

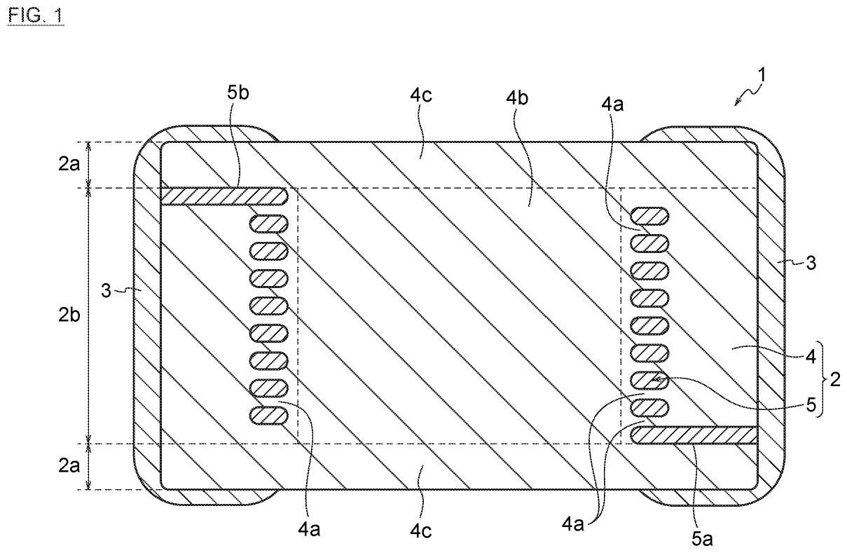

A multilayer inductor 1 shown in FIG. 1 exemplifies a coil-type electronic component.

As shown in FIG. 1, the multilayer inductor 1 according to the present embodiment includes an element 2 and terminal electrodes 3. The element 2 has a structure in which a coil conductor 5 is three-dimensionally and spirally embedded inside a magnetic element body 4. At both ends of the element 2, the terminal electrodes 3 are formed, and these terminal electrodes 3 are connected to the coil conductor 5 by leading electrodes 5a and 5b. The element 2 is made up of a center region 2b and surface regions 2a. The center region 2b is where the coil conductor 5 is embedded. The surface regions 2a are where the coil conductor 5 is not embedded, on top and bottom of the center region 2b in the lamination direction.

As shown in FIG. 1, a region of the magnetic element body 4 is defined as a coil inner-diameter region 4b. This region is in the same position as the center region 2b in the lamination direction and is inwardly apart from part of the coil conductor 5 closest to its axis by 3% or more of the distance between the axis and the part in the radial direction of the coil conductor 5.

As shown in FIG. 1, regions of the magnetic element body 4 that are located in the surface regions 2a in the lamination direction are defined as cover regions 4c.

In the magnetic element body 4, a region that is not included in the coil inner-diameter region 4b or the cover regions 4c is defined as a remaining region 4a.

The element 2 may have any shape and usually has a rectangular parallelepiped shape. The element 2 may have any size that is appropriate for its usage. For example, the element 2 may have a size of 0.2 to 2.5 mm×0.1 to 2.0 mm×0.1 to 1.2 mm.

The terminal electrodes 3 may be made from any electrically conductive material. For example, Ag, Cu, Au, Al, a Ag alloy, or a Cu alloy may be used. In particular, Ag is preferably used, because Ag is inexpensive and has low electrical resistance. The terminal electrodes 3 may include a material other than the electrically conductive material. For example, the terminal electrodes 3 may include glass frit.

Surfaces of the terminal electrodes 3 may be plated. For example, Cu plating, Ni plating, or Sn plating may be formed. Both the Ni plating and the Sn plating may be formed in the order mentioned.

The coil conductor 5 and the leading electrodes 5a and 5b may be made from any electrically conductive material. For example, Ag, Cu, Au, Al, a Ag alloy, or a Cu alloy may be used. In particular, Ag is preferably used, because Ag is inexpensive and has low electrical resistance.

The magnetic element body 4 may include soft magnetic metal particles and a resin. In the magnetic element body 4, part other than the soft magnetic metal particles is a space. The space may partly or completely be filled with the resin, and part of the space not filled with the resin is a void. Before the space is filled with the resin, the space is entirely a void.

Filling the resin into the space increases the strength of the multilayer inductor 1. The resin also further improves insulation among the soft magnetic metal particles, thereby further increasing the Q factor of the multilayer inductor 1. Additionally, the reliability and heat resistance of the multilayer inductor 1 increase.

The resin may be any type of resin. Specifically, the resin may be a phenol resin or an epoxy resin. In particular, a phenol resin is preferably used for being inexpensive and easy to handle.

### Soft Magnetic Metal Particles

At least some of the soft magnetic metal particles included in the magnetic element body 4 are made of an Fe—Ni based soft magnetic metal.

The Fe—Ni based soft magnetic metal mainly contains Fe and Ni. Specifically, the Fe—Ni based soft magnetic metal is a soft magnetic metal containing 20 mass % or more of Fe and 20 mass % or more of Ni.

The soft magnetic metal particles made of the Fe—Ni based soft magnetic metal may contain Fe, Ni, and Co as a main component. Specifically, the soft magnetic metal particles may contain 20 mass % or more of Fe, 10 mass % or more of Ni, and 3 mass % or more of Co.

Also, the Fe—Ni based soft magnetic metal may contain Fe, Ni, and Co as a main component and may further contain at least one selected from the group consisting of Si, Cr, and P. The Fe—Ni based soft magnetic metal may contain 1 mass % or more and 6 mass % or less of Si, 0.2 mass % or more and 5 mass % or less of Cr, and 0.01 mass % or more and 1 mass % or less of P.

The Fe—Ni based soft magnetic metal may contain 3 parts by mass or less of other elements with respect to 100 parts by mass of the total of Fe, Ni, Co, Si, Cr, and P.

At least some of the soft magnetic metal particles made of the Fe—Ni based soft magnetic metal each include a face-centered cubic (fcc) phase and a body-centered cubic (bcc) phase. The fcc phase is a phase having a face-centered cubic structure. The bcc phase is a phase having a body-centered cubic structure. Hereinafter, the soft magnetic metal particles each of which is made of the Fe—Ni based soft magnetic metal and includes both the fcc phase and the bcc phase may simply be referred to as “specific soft magnetic metal particles.”

When the magnetic element body 4 is manufactured using the specific soft magnetic metal particles, they are efficiently rearranged at the time of shaping, thereby increasing the metal space factor of the magnetic element body 4. This is because efficient rearrangement of the soft magnetic metal particles optimizes their arrangement. Further, the specific soft magnetic metal particles have high saturation magnetization (Ms). Thus, when the magnetic element body 4 is manufactured using the specific soft magnetic metal particles, the magnetic element body 4 can have high saturation magnetization (Ms) and a high metal space factor at the same time. As a result, the DC superimposition characteristics of the multilayer inductor 1 improve.

This is because the fcc phase has relatively low hardness whereas the bcc phase has relatively high hardness.

When the soft magnetic metal particles include only the fcc phase, plastic deformation of the soft magnetic metal particles readily occurs before they are sufficiently rearranged. Plastic deformation of the soft magnetic metal particles readily makes it difficult for the soft magnetic metal particles to be rearranged. Thus, when the soft magnetic metal particles include only the fcc phase, the magnetic element body 4 readily has a low metal space factor.

Even when plastic deformation of the soft magnetic metal particles does not occur fully, the magnetic element body 4 does not have a sufficiently high metal space factor. When the soft magnetic metal particles include only the bcc phase, their plastic deformation is too difficult to occur, and the magnetic element body 4 thus readily has a low metal space factor.

The specific soft magnetic metal particles may be located anywhere in the magnetic element body 4.

The specific soft magnetic metal particles may be included in the coil inner-diameter region 4b and the cover regions 4c of the magnetic element body 4. It may be that the specific soft magnetic metal particles are substantially included only in the coil inner-diameter region 4b and the cover regions 4c of the magnetic element body 4. When the specific soft magnetic metal particles are substantially included only in the coil inner-diameter region 4b and the cover regions 4c of the magnetic element body 4, the multilayer inductor 1 readily has, in particular, improved inductance and improved DC superimposition characteristics in a well-balanced manner.

The specific soft magnetic metal particles may be included in all of the remaining region 4a, the coil inner-diameter region 4b, and the cover regions 4c of the magnetic element body 4. When the specific soft magnetic metal particles are included in all of the remaining region 4a, the coil inner-diameter region 4b, and the cover regions 4c of the magnetic element body 4, the multilayer inductor 1 readily has, in particular, a high withstand voltage.

When the specific soft magnetic metal particles are included in the magnetic element body 4, the specific soft magnetic metal particles may be included therein at any proportion. In terms of the number of particles, 10% or more of all soft magnetic metal particles included in the magnetic element body 4 may be the specific soft magnetic metal particles.

When the specific soft magnetic metal particles are included in the coil inner-diameter region 4b, the specific soft magnetic metal particles may be included therein at any proportion. In terms of the number of particles, 10% or more of all soft magnetic metal particles included in the coil inner-diameter region 4b may be the specific soft magnetic metal particles.

When the specific soft magnetic metal particles are included in the cover regions 4c, the specific soft magnetic metal particles may be included therein at any proportion. In terms of the number of particles, 10% or more of all soft magnetic metal particles included in the cover regions 4c may be the specific soft magnetic metal particles.

When the specific soft magnetic metal particles are substantially included only in the coil inner-diameter region 4b and the cover regions 4c, less than 10% of all soft magnetic metal particles included in the remaining region 4a is the specific soft magnetic metal particles in terms of the number of particles. In contrast, when the specific soft magnetic metal particles are included in the remaining region 4a, the specific soft magnetic metal particles may be included therein at any proportion. In terms of the number of particles, 10% or more of all soft magnetic metal particles included in the remaining region 4a may be the specific soft magnetic metal particles.

The magnetic element body 4 may include soft magnetic metal particles other than the specific soft magnetic metal particles. For example, the magnetic element body 4 may include soft magnetic metal particles each of which is made of the Fe—Ni based soft magnetic metal but does not include both the fcc phase and the bcc phase, or may include soft magnetic metal particles made of a soft magnetic metal other than the Fe—Ni based soft magnetic metal. For example, the magnetic element body 4 may include soft magnetic metal particles made of an Fe—Si based soft magnetic metal.

The Fe—Si based soft magnetic metal mainly contains Fe and Si. Specifically, the Fe—Si based soft magnetic metal is a soft magnetic metal containing 90 mass % or more of Fe and 1 mass % or more of Si.

The Fe—Si based soft magnetic metal may further contain Cr and/or P in addition to Fe and Si. The Fe—Si based soft magnetic metal may contain 0.5 mass % or more and 8 mass % or less of Cr and 0.01 mass % or more and 1 mass % or less of P.

The Fe—Si based soft magnetic metal may contain 3 parts by mass or less of other elements with respect to 100 parts by mass of the total of Fe, Si, Cr, and P.

When the specific soft magnetic metal particles are substantially included only in the coil inner-diameter region 4b and the cover regions 4c, the remaining region 4a may include the soft magnetic metal particles made of the Fe—Si based soft magnetic metal. In this case, the multilayer inductor 1 readily has well-balanced inductance and DC superimposition characteristics, compared to when all of the remaining region 4a, the coil inner-diameter region 4b, and the cover regions 4c include the specific soft magnetic metal particles. In contrast, when all of the remaining region 4a, the coil inner-diameter region 4b, and the cover regions 4c include the specific soft magnetic metal particles, the multilayer inductor 1 readily has a high withstand voltage.

The soft magnetic metal particles included in the magnetic element body 4 may have any average particle size (D50). For example, D50 may be 0.5 μm or more and 15 μm or less.

The soft magnetic metal particles may have different average particle sizes in the coil inner-diameter region 4b, the cover regions 4c, and the remaining region 4a. In particular, when the specific soft magnetic metal particles are substantially included only in the coil inner-diameter region 4b and the cover regions 4c, the average particle size of the soft magnetic metal particles included in the coil inner-diameter region 4b and the average particle size of the soft magnetic metal particles included in the cover regions 4c are preferably larger than the average particle size of the soft magnetic metal particles included in the remaining region 4a. In this case, the average particle size of the soft magnetic metal particles included in the coil inner-diameter region 4b and the average particle size of the soft magnetic metal particles included in the cover regions 4c may be 5 μm or more and 20 μm or less, and the average particle size of the soft magnetic metal particles included in the remaining region 4a may be 0.5 μm or more and 5 μm or less.

A value calculated by dividing the average particle size of the soft magnetic metal particles included in the remaining region 4a by the average particle size of the soft magnetic metal particles included in the coil inner-diameter region 4b may be 0.025 or more and 0.70 or less. A value calculated by dividing the average particle size of the soft magnetic metal particles included in the remaining region 4a by the average particle size of the soft magnetic metal particles included in the cover regions 4c may be 0.025 or more and 0.70 or less.

When the average particle size of the soft magnetic metal particles included in the coil inner-diameter region 4b and the average particle size of the soft magnetic metal particles included in the cover regions 4c are larger than the average particle size of the soft magnetic metal particles included in the remaining region 4a, the multilayer inductor 1 readily has well-balanced inductance and DC superimposition characteristics, compared to when the respective average particle sizes of the soft magnetic metal particles included in the remaining region 4a, the coil inner-diameter region 4b, and the cover regions 4c are about the same.

The soft magnetic metal particles may each have a soft magnetic metal particle core and an oxidized film that covers the soft magnetic metal particle core. The oxidized film may have any thickness. For example, the oxidized film may have an average thickness of 5 nm or more and 60 nm or less. The oxidized film may be formed by any method. For example, the oxidized film can be formed by firing a soft magnetic metal powder including the soft magnetic metal particles.

### Confirming Whether Both fcc Phase and bcc Phase are Included in One Particle

Hereinafter, a method of determining whether both the fcc phase and the bcc phase are included in one soft magnetic metal particle will be explained.

Any method may be used to determine whether both the fcc phase and the bcc phase are included in one soft magnetic metal particle. For example, electron backscatter diffraction (EBSD) may be used.

EBSD is a technique in which a diffraction pattern (an EBSD pattern) is measured and analyzed with a scanning electron microscope (SEM) to measure the crystal orientation and the crystal system of a crystalline material.

The EBSD pattern is made up of intersecting bands. One band is generated by diffraction of one crystal face. The width and the intensity of the band are dependent on the crystal structure (e.g., lattice constant). The angles at which the bands intersect and the locations of the bands are determined in accordance with the crystal orientation. Thus, analyzing the EBSD pattern allows crystal phase identification and crystal orientation measurement.

When EBSD is used, for example, a sample is placed in a lens barrel of a SEM in a tilted manner. At this time, irradiating the sample with an electron beam projects an EBSD pattern on the screen of an EBSD detector. This EBSD pattern is imaged with the EBSD detector (CCD detector). The acquired image is analyzed by a predetermined method (e.g., Hough transform) and compared with a simulation pattern of a known crystal structure database to determine the crystal phase and the crystal orientation.

The determined crystal phase and the determined crystal orientation are recorded with the coordinates. Thus, creation and analysis of crystal phase mapping, crystal orientation mapping, and the like are possible. Performing elemental mapping using EDX at the same time allows comprehensive material analysis in which elemental composition information and crystal structure information are integrated.

When EBSD analysis of the magnetic element body 4 of the multilayer inductor 1 is performed, first, a portion of the magnetic element body 4 subject to measurement is irradiated with an electron beam. The electron backscatter diffraction generated by diffracted electrons at each crystal face of the soft magnetic metal particles is analyzed. This allows for determination of whether the fcc phase and the bcc phase are both included in one soft magnetic metal particle. Even when there is a plurality of soft magnetic metal particles, it is possible to determine whether each soft magnetic metal particle includes the fcc phase and the bcc phase or whether both the soft magnetic metal particles including only the fcc phase and the soft magnetic metal particles including only the bcc phase are mixed.

Another method of determining whether both the fcc phase and the bcc phase are included in one soft magnetic metal particle is an electron diffraction method using a transmission electron microscope (TEM). Although the electron diffraction method is identical to EBSD in principle, a measurement apparatus is different from the one used in EBSD. When the electron diffraction method is used, the magnetic element body 4 is sectioned and thinned and is irradiated with an electron beam to give a diffraction pattern. Using the diffraction pattern, the crystal structure of the irradiated portion of the magnetic element body 4 can be examined. Similarly to EBSD, even when there is a plurality of soft magnetic metal particles, it is possible to determine whether each soft magnetic metal particle includes the fcc phase and the bcc phase or whether both the soft magnetic metal particles including only the fcc phase and the soft magnetic metal particles including only the bcc phase are mixed.

### Existence Ratio of bcc Phase to fcc Phase

When both the fcc phase and the bcc phase are included in one soft magnetic metal particle, the existence ratio of the bcc phase to the fcc phase may be any ratio. In a diffraction chart generated by X-ray diffraction analysis, a value (may simply be referred to as a “bcc/fcc ratio”) calculated by dividing the diffraction peak intensity of the bcc phase by the diffraction peak intensity of the fcc phase is preferably 0.01 or more and 0.80 or less. The diffraction peak of the fcc phase appears around 2θ=43.5° to 44.0°. The diffraction peak of the bcc phase appears around 2θ=44.5° to 45.2°.

When all of the remaining region 4a, the coil inner-diameter region 4b, and the cover regions 4c of the multilayer inductor 1 include the specific soft magnetic metal particles as mentioned above, the bcc/fcc ratio is preferably 0.30 or more and 0.80 or less.

When only the coil inner-diameter region 4b and the cover regions 4c of the multilayer inductor 1 substantially include the specific soft magnetic metal particles as mentioned above, the bcc/fcc ratio is preferably 0.01 or more and 0.40 or less.

The bcc/fcc ratio does not necessarily agree with a value calculated by dividing the existence ratio of the bcc phase by the existence ratio of the fcc phase. It is generally because diffraction peak intensities vary depending on crystal phase types.

Any number of soft magnetic metal particles may be subjected to X-ray diffraction analysis. When a plurality of multilayer inductors 1 are being manufactured under the same conditions, a plurality of magnetic element bodies 4 may be lined up in the measurement range for X-ray diffraction analysis to give a diffraction chart. Powder X-ray diffraction analysis may be performed to give a diffraction chart of the soft magnetic metal powder including the soft magnetic metal particles.

The field of view of X-ray diffraction analysis may be about φ 10 μm. This means that a diffraction chart of one soft magnetic metal particle may be generated through X-ray diffraction analysis of a field of view of about φ 10 μm.

### Method of Manufacturing Multilayer Inductor

A method of manufacturing the multilayer inductor will be explained. First, a method of manufacturing the soft magnetic metal powder, which is a material of the soft magnetic metal particles constituting the magnetic element body, will be explained.

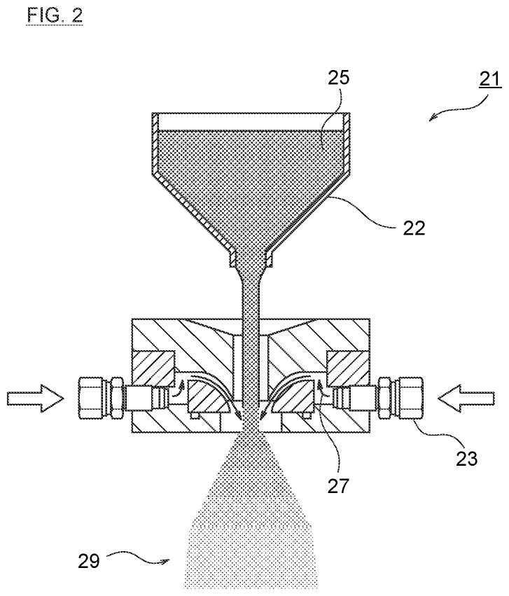

The soft magnetic metal powder including the soft magnetic metal particles each including the fcc phase and the bcc phase can be manufactured by a water atomization method using a water atomization apparatus 21 shown in FIG. 2.

In the water atomization method, typically, a molten metal 25 is supplied as a linear continuous fluid through a nozzle provided at the bottom of a tundish 22. High-pressure water 27 is sprayed through an atomizing nozzle 23 to the molten metal 25. The molten metal 25 is thus formed into droplets to give an atomized powder 29. The atomized powder 29 is rapidly cooled using cooling means (e.g., cooling water) to give a fine metal powder.

The present inventors have found that using the molten metal 25 made of the Fe—Ni based soft magnetic metal and controlling the cooling speed of the molten metal 25 by regulating the amount and the pressure of the high-pressure water 27 allow each of the soft magnetic metal particles to include the fcc phase and the bcc phase.

Specifically, the amount of the high-pressure water 27 is 200 L/min or more, and the pressure thereof is 20 MPa or more and 40 MPa or less. In particular, if a normal water atomization method is used, the above-mentioned amount of water is excessive and leads to high manufacturing costs. However, when the molten metal 25 made of the Fe—Ni based soft magnetic metal is used, 200 L/min or more of the high-pressure water 27 allows each of the soft magnetic metal particles to include the fcc phase and the bcc phase.

There is no upper limit of the amount of the high-pressure water 27. The larger the water amount, the larger the bcc/fcc ratio tends to be. For example, the upper limit may be 500 L/min or less.

Other conditions may be the same as those of the normal water atomization method to give the soft magnetic metal powder.

Next, using the soft magnetic metal powder given as such, the multilayer inductor is manufactured. A method of manufacturing the multilayer inductor may be any known method. Hereinafter, a method of manufacturing the multilayer inductor using a sheet method will be explained.

The soft magnetic metal powder is turned into slurry together with additives (e.g., a solvent and a binder) to produce a paste. Using this paste, green sheets, which become the magnetic element body after firing, are formed. At this time, different pastes including different soft magnetic metal powders may be used as appropriate to give the magnetic element body as intended. On the green sheets, a coil conductor paste is applied to form coil conductor patterns. The coil conductor paste is produced by turning a metal (e.g., Ag) that becomes the coil conductor into slurry together with additives (e.g., a solvent and a binder). Next, the green sheets having the coil conductor patterns are laminated. Then, the coil conductor patterns are bonded. This gives a green multilayer body in which the coil conductor is formed three dimensionally and spirally.

The green multilayer body is subjected to heating (a binder removal step and a firing step) to remove the binder and to turn the soft magnetic metal particles included in the soft magnetic metal powder into fired soft magnetic metal particles. This gives a fired multilayer body in which the fired soft magnetic metal particles are connected and fixed to (integrated with) each other. The holding temperature (binder removal temperature) in the binder removal step may be any temperature at which the binder can be decomposed and removed as a gas and is preferably 300° C. to 450° C. The holding time (binder removal time) in the binder removal step may be any amount of time and is preferably 0.5 to 2.0 hours.

The holding temperature (firing temperature) in the firing step may be any temperature at which the soft magnetic metal particles constituting the soft magnetic metal powder connect to each other and is preferably 550° C. to 850° C. The holding time (firing time) in the firing step may be any amount of time and is preferably 0.5 to 3.0 hours in the present embodiment.

The binder removal atmosphere and the firing atmosphere are preferably adjusted. Specifically, although binder removal and firing may be carried out in an oxidizing atmosphere (e.g., in the air), binder removal and firing are preferably carried out in an atmosphere having less oxidizing power than the air. For example, binder removal and firing are preferably carried out in a nitrogen atmosphere or a mixed atmosphere of nitrogen and hydrogen. Thus, the soft magnetic metal particles can have a high specific resistance, and the magnetic element body can have a high density, a high permeability, and the like. Also, a Si oxidized film is readily formed on the surfaces of the soft magnetic metal particles, and Fe oxides are not readily formed. As a result, reduction of inductance due to oxidation of Fe can be prevented.

Annealing may be performed after firing. Annealing may be performed under any conditions. For example, annealing may be performed at 500° C. to 800° C. for 0.5 to 2.0 hours. A post-annealing atmosphere may also be any atmosphere.

Note that the composition of the soft magnetic metal particles after heating is substantially the same as the composition of the soft magnetic metal powder prior to heating.

Next, the terminal electrodes are formed on the element. Any method may be used to form the terminal electrodes. Normally, a metal (e.g., Ag) that becomes the terminal electrodes is turned into slurry together with additives (e.g., a solvent and a binder) to form the terminal electrodes.

Next, the element may be impregnated with the resin. Impregnating the element with the resin fills the resin into the space. Any method may be used to impregnate the element with the resin. For example, a vacuum impregnation method may be used.

When the element is impregnated with the resin, the amount of the resin in the magnetic element body of the multilayer inductor in the end may be 0.5 wt % or more and 3.0 wt % or less.

In the present embodiment, electroplating may be carried out on the terminal electrodes after resin filling. Because the space is filled with the resin, even when the multilayer inductor is put into a plating solution, the plating solution scarcely enters inside the magnetic element body. Thus, a short circuit does not occur inside the multilayer inductor even after plating, and the inductance is maintained high.

Hereinabove, one embodiment of the present invention has been explained, but the present invention is not limited to the above-mentioned embodiment and may variously be modified within the scope of the invention.

### Examples

Hereinafter, the present invention will be explained in detail using examples. However, the present invention is not limited to these examples.

### Experiment 1

### Manufacture of Soft Magnetic Metal Powder

First, simple substances of Fe, Ni, Co, Si, and Cr were prepared as raw materials. Next, they were mixed and placed in a crucible. Next, in an inert atmosphere, the crucible was heated to 1600° C. or higher by high frequency induction heating using a work coil provided outside the crucible. The ingots, chunks, or shots in the crucible were thus melted and mixed to give a molten metal. Note that the amount of P was adjusted by controlling the amount of P in the raw material of the simple substance of Fe when the raw materials of the soft magnetic metal powder were melted and mixed.

Next, the molten metal 25 was supplied from the crucible to a tundish 22 of a water atomization apparatus 21 shown in FIG. 2. Then, the molten metal 25 as a linear continuous fluid was supplied from the tundish 22, and high-pressure water 27 was sprayed to collide with the molten metal 25. At this time, the amount of the high-pressure water 27 was as shown in Table 1. The pressure of the high-pressure water 27 was 40 MPa.

The molten metal 25 was formed into droplets to give an atomized powder 29. The atomized powder 29 was rapidly cooled with cooling water and was then dehydrated, dried, and classified to give the soft magnetic metal powder of each Sample shown in Table 1. Note that conditions such as manufacturing conditions and classification conditions were appropriately controlled to control the average particle size in each Sample.

Through composition analysis of the soft magnetic metal powder using an ICP analysis method, it was confirmed that the composition of each Sample was as shown in Table 1. It was also confirmed that elements not shown in Table 1 were substantially not contained.

### Measurement of Saturation Magnetization (Ms) of Soft Magnetic Metal Powder

The saturation magnetization (Ms) of the soft magnetic metal powder of each Sample was measured with a vibrating sample magnetometer (VSM-3S-15 manufactured by Toei Industry Co., Ltd.) at an external magnetic field of 795.8 kA/m (10 kOe). Table 1 shows the results. In Experiment 1, the saturation magnetization (Ms) was regarded as good when it exceeded 1.50 T.

### Manufacture of Multilayer Inductor

The soft magnetic metal powder was turned into slurry together with additives (e.g., a solvent and a binder) to produce a paste. Using this paste, green sheets, which would become a magnetic element body after firing, were formed. Predetermined patterns of a Ag conductor (coil conductor) were formed on these green sheets, and these green sheets were laminated to give a green multilayer body having a thickness of 0.8 mm. The number of coil windings was 7.5 Ts.

The green multilayer body was cut into 1.6 mm×0.8 mm to give green multilayer inductors. The green multilayer inductors were subjected to binder removal at 400° C. in an inert atmosphere and then fired at 750° C. for 1 hour in a reducing atmosphere to give fired bodies. The inert atmosphere was a Na gas atmosphere. The reducing atmosphere was a N₂ and H₂ mixed gas atmosphere (hydrogen concentration: 1.0%).

On both end surfaces of the respective fired bodies, a terminal electrode paste was applied. The paste was dried and then baked at 700° C. for 1 hour in an atmosphere having an oxygen partial pressure of 1% to form terminal electrodes. This gave baked multilayer inductors.

Next, the baked multilayer inductors were impregnated with a resin. Specifically, the baked multilayer inductors were vacuum-impregnated with a raw material mixture of a phenol resin. The baked multilayer inductors were then heated so that the resin hardened to fill the baked multilayer inductors. Heating at 150° C. for 2 hours hardened the resin. Note that, when the resin hardened, a solvent and the like included in the raw material mixture of the phenol resin vaporized.

Then, Ni and Sn plating layers were formed on the terminal electrodes by electroplating to give multilayer inductors 1 shown in FIG. 1. Note that the coil conductor 5 had a thickness of 40 μm and its interlayer part (part between layers of the coil conductor) had a thickness of 15 μm.

The composition of the magnetic element body 4 was checked using the ICP analysis method. It was confirmed that the composition of soft magnetic metal particles included in the magnetic element body 4 was substantially the same as the composition of the soft magnetic metal powder.

Confirming Whether Both Bcc Phase and Fcc Phase were Included in One Particle

Whether both a bcc phase and an fcc phase were included in one soft magnetic metal particle in the magnetic element body 4 was checked using EBSD. It was confirmed that, in all Examples, each of soft magnetic metal particles made of an Fe—Ni based soft magnetic metal included the bcc phase and the fcc phase.

### Measurement of Bcc/Fcc Ratio of Soft Magnetic Metal Particles

The bcc/fcc ratio of the soft magnetic metal particles in the magnetic element body 4 was identified by X-ray diffraction analysis. Table 1 shows the results. Note that, in Table 1, “fcc only” indicates that the diffraction peak of the bcc phase was not detected, and “bcc only” indicates that the diffraction peak of the fcc phase was not detected. When represented in a numerical value, “fcc only” is 0.00.

### Measurement of Average Particle Size

A sectional image of the magnetic element body 4 of the multilayer inductor 1 was analyzed with a SEM to find the equivalent circular diameters of the soft magnetic metal particles. A field of view was determined so as to include four hundred or more soft magnetic metal particles, and the equivalent circular diameters of these soft magnetic metal particles in the field of view were measured. The equivalent circular diameters of these soft magnetic metal particles were averaged to calculate the average particle size of the soft magnetic metal particles. In Experiment 1, it was confirmed that the average particle size of the soft magnetic metal particles was about 3 μm in all Examples and Comparative Examples.

### Measurement of Soft Magnetic Metal Particle Space Factor

The ratio of the total area of the soft magnetic metal particles in the above-mentioned field of view to the total area of the magnetic element body 4 in the above-mentioned field of view was defined as “soft magnetic metal particle space factor.” Table 1 shows the results. In Experiment 1, the soft magnetic metal particle space factor was regarded as good when it exceeded 60% and was regarded as better when it exceeded 70%.

### Measurement of Saturation Magnetization of Soft Magnetic Metal Particles

A part of the magnetic element body 4 of the multilayer inductor 1 was extracted by microfabrication through laser processing. The saturation magnetization of the soft magnetic metal particles in the magnetic element body 4 was measured with a vibrating sample magnetometer (VSM-3S-15 manufactured by Toei Industry Co., Ltd.) at an external magnetic field of 795.8 kA/m (10 kOe). Consequently, it was confirmed that, in all Examples and Comparative Examples, the saturation magnetization of the soft magnetic metal particles in the magnetic element body 4 was the same as the saturation magnetization of the soft magnetic metal powder. In Experiment 1, the saturation magnetization (Ms) was regarded as good when it exceeded 1.50 T.

### Measurement of Inductance and Isat

While the inductance of the multilayer inductor 1 was being measured with an LCR meter (4285A manufactured by HEWLETT PACKARD), a direct current was applied starting from 0. The measurement frequency of the inductance was 2 MHz, and the measurement current was 0.1 A.

Provided that L (unit: μH) was the inductance at which the applied direct current was 0, a direct current at which the inductance was reduced to 0.70×L was defined as Isat (unit: A). The Isat values shown in Table 1 are values calculated by averaging the Isat values of thirty multilayer inductors for respective Examples and Comparative Examples. In Experiment 1, DC superimposition characteristics were regarded as good when the Isat value was 1.60 A or more.

Table 1 shows L×Isat (unit: μV·s), which is an index for evaluating the balance between the inductance and the DC superimposition characteristics. The L×Isat index was regarded as good at 1.10 μV·s or more and better at 1.60 μV·s or more.

### Measurement of Withstand Voltage

An impulse voltage was applied to the multilayer inductor using an impulse tester (DWX-300LI manufactured by ECG KOKUSAI CO., LTD.). The inductance was measured again after the impulse voltage was applied.

Using a plurality of multilayer inductors manufactured under the same conditions, the same test was carried out under application of the impulse voltage in increments of 1 V. The inductance decrease rate caused by application of the impulse voltage was calculated.

Among the impulse voltages applied to the multilayer inductors having an inductance decrease rate of 10% or less, the largest impulse voltage was regarded as the withstand voltage. The withstand voltage was regarded as good at 10 V or more and better at 20 V or more.

TABLE 1

| | | | | | Soft magnetic | | | | |
|---|---|---|---|---|---|---|---|---|---|
| | | Water | | | metal particle | | | | Withstand |
| | Composition | amount | bcc/ | Ms | space factor | L | Isat | L × Isat | voltage |
| Sample No. | (Mass ratio) | [L/min] | fcc | [T] | [%] | [μH] | [A] | [μV · s] | [V] |
| Comparative | Fe₂₀Ni₈₀ | 163 | fcc only | 1.00 | 79 | 0.40 | 1.19 | 0.47 | 1 |
| Example 1 | | | | | | | | | |
| Comparative | Fe₈₀Ni₂₀ | 163 | bcc only | 1.78 | 55 | 0.26 | 1.47 | 0.38 | 1 |
| Example 2 | | | | | | | | | |
| Example 1 | Fe₆₈Ni₃₂ | 220 | 0.80 | 1.55 | 70 | 0.72 | 1.55 | 1.12 | 18 |
| Example 2 | Fe₄₄Ni₂₂Co₃₄ | 380 | 0.80 | 1.80 | 64 | 0.68 | 1.73 | 1.18 | 18 |
| Example 3 | Fe₄₃Ni₂₄Co₃₀Si₃ | 270 | 0.40 | 1.60 | 80 | 0.60 | 1.92 | 1.15 | 25 |
| Example 4 | Fe₄₂Ni₂₄Co₃₀Si₃Cr₁ | 281 | 0.19 | 1.56 | 82 | 0.62 | 1.92 | 1.19 | 30 |
| Comparative | Fe_{41.9}Ni₂₄Co₃₀Si₃Cr₁P_{0.1} | 100 | fcc only | 1.50 | 70 | 0.55 | 1.58 | 0.87 | 5 |
| Example 3 | | | | | | | | | |
| Example 5 | Fe_{41.9}Ni₂₄Co₃₀Si₃Cr₁P_{0.1} | 200 | 0.01 | 1.55 | 85 | 0.60 | 1.98 | 1.19 | 38 |
| Example 6 | Fe_{41.9}Ni₂₄Co₃₀Si₃Cr₁P_{0.1} | 222 | 0.08 | 1.54 | 83 | 0.61 | 1.92 | 1.17 | 40 |
| Example 7 | Fe_{41.9}Ni₂₄Co₃₀Si₃Cr₁P_{0.1} | 270 | 0.21 | 1.55 | 82 | 0.61 | 1.91 | 1.16 | 40 |
| Example 8 | Fe_{41.9}Ni₂₄Co₃₀Si₃Cr₁P_{0.1} | 349 | 0.50 | 1.55 | 79 | 0.61 | 1.84 | 1.12 | 38 |
| Example 9 | Fe_{41.9}Ni₂₄Co₃₀Si₃Cr₁P_{0.1} | 403 | 0.80 | 1.56 | 74 | 0.60 | 1.83 | 1.10 | 33 |

According to Table 1, each of the soft magnetic metal particles in the soft magnetic metal powders of Examples 1 to 9 included the fcc phase and the bcc phase. The multilayer inductors manufactured using these soft magnetic metal powders had high saturation magnetization (Ms) of the soft magnetic metal particles in the magnetic element body, a high soft magnetic metal particle space factor, a high withstand voltage, and high DC superimposition characteristics.

In Comparative Example 1, the soft magnetic metal powder did not include the bcc phase. In Comparative Example 1, the soft magnetic metal particle space factor of the magnetic element body was high, but the saturation magnetization (Ms) was low, and the multilayer inductors had a low withstand voltage and low DC superimposition characteristics.

In Comparative Example 2, the soft magnetic metal powder did not include the fcc phase. In Comparative Example 2, the saturation magnetization (Ms) of the soft magnetic metal particles in the magnetic element body was high, but the soft magnetic metal particle space factor was low, and the multilayer inductors had a low withstand voltage and low DC superimposition characteristics.

In Comparative Example 3, the soft magnetic metal powder did not include the bcc phase. In Comparative Example 3, the soft magnetic metal particle space factor of the magnetic element body was high, but the saturation magnetization (Ms) was low, and the multilayer inductors had a low withstand voltage and low DC superimposition characteristics.

### Experiment 2

In Experiment 2, soft magnetic metal particles having different compositions and/or different average particle sizes were included in a coil inner-diameter region 4b, cover regions 4c (top and bottom), and a remaining region 4a of the magnetic element body 4 of the multilayer inductor 1.

In accordance with the intended magnetic element body 4 of the multilayer inductor 1, different soft magnetic metal powders were manufactured. The powders were each turned into slurry and then into different pastes. The different pastes were used accordingly to form green sheets that would become the intended magnetic element body 4 after firing.

The average particle size of the soft magnetic metal particles was about 10 μm in the coil inner-diameter region 4b and the cover regions 4c (top and bottom) and about 3 μm in the remaining region 4a.

Table 2 shows the compositions of the soft magnetic metal particles included in the coil inner-diameter region 4b, the cover regions 4c (top and bottom), and the remaining region 4a.

Other conditions of Experiment 2 were the same as those of Experiment 1. Table 2 shows the results.

TABLE 2

| | Coil inner-diameter region | | Cover regions (top and bottom) | | | |
|---|---|---|---|---|---|---|
| | Composition | bcc/ | Composition | | | bcc/ |
| Sample No. | (Mass ratio) | fcc | (Mass ratio) | | | fcc |
| Comparative Example 11 | Fe 20Ni80 | fcc only | Fe₂₀Ni₈₀ | | | fcc only |
| Comparative Example 12 | Fegg Ni20 | bcc only | Fe₈₀Ni₂₀ | | | bcc only |
| Comparative Example 13 | Fe_{41.9}Ni₂₄Co₃₀Si₃Cr₁P_{0.1} | fcc only | Fe_{41.9}Ni₂₄Co₃₀Si₃Cr₁P_{0.1} | | | fcc only |
| Example 11 | Fe_{41.9}Ni₂₄Co₃₀Si₃Cr₁P_{0.1} | 0.20 | Fe_{41.9}Ni₂₄Co₃₀Si₃Cr₁P_{0.1} | | | 0.20 |
| Example 12 | Fe_{41.9}Ni₂₄Co₃₀Si₃Cr P_{0.1} | 0.50 | Fe_{41.9}Ni₂₄Co₃₀Si₃Cr₁P_{0.1} | | | 0.50 |
| Example 13 | Fe_{41.9}Ni₂₄Co₃₀Si₃Cr P_{0.1} | 0.20 | Fe_{41.9}Ni₂₄Co₃₀Si₃Cr₁P_{0.1} | | | 0.20 |
| Example 14 | Fe_{41.9}Ni₂₄Co₃₀Si₃Cr₁P_{0.1} | 0.29 | Fe_{41.9}Ni₂₄Co₃₀Si₃Cr₁P_{0.1} | | | 0.29 |
| Example 15 | Fe_{41.9}Ni₂₄Co₃₀Si₃Cr₁P_{0.1} | 0.30 | Fe_{41.9}Ni₂₄Co₃₀Si₃Cr₁P_{0.1} | | | 0.30 |
| Example 12 | Fe_{41.9}Ni₂₄Co₃₀Si₃Cr₁P_{0.1} | 0.50 | Fe_{41.9}Ni₂₄Co₃₀Si₃Cr₁P_{0.1} | | | 0.50 |
| Example 16 | Fe_{41.9}Ni₂₄Co₃₀Si₃Cr₁P_{0.1} | 0.80 | Fe_{41.9}Ni₂₄Co₃₀Si₃Cr₁P_{0.1} | | | 0.80 |
| Example 17 | Fe_{41.9}Ni₂₄Co₃₀Si₃Cr₁P_{0.1} | 0.81 | Fe_{41.9}Ni₂₄Co₃₀Si₃Cr₁P_{0.1} | | | 0.81 |
| Comparative Example 14 | Fe_{41.9}Ni₂₄Co₃₀Si₃Cr₁P_{0.1} | fcc only | Fe_{41.9}Ni₂₄Co₃₀Si₃Cr₁P_{0.1} | | | fcc only |
| Example 18 | Fe_{41.9}Ni₂₄Co₃₀Si₃Cr₁P_{0.1} | 0.41 | Fe_{41.9}Ni₂₄Co₃₀Si₃Cr₁P_{0.1} | | | 0.41 |
| Example 19 | Fe_{41.9}Ni₂₄Co₃₀Si₃Cr₁P_{0.1} | 0.01 | Fe_{41.9}Ni₂₄Co₃₀Si₃Cr₁P_{0.1} | | | 0.01 |
| Example 20 | Fe_{41.9}Ni₂₄Co₃₀Si₃Cr₁P_{0.1} | 0.40 | Fe_{41.9}Ni₂₄Co₃₀Si₃Cr₁P_{0.1} | | | 0.40 |
| | Remaining region | | | | | Withstand |
| | Composition | bcc/ | L | Isat | L × Isat | voltage |
| Sample No. | (Mass ratio) | fcc | [μH] | [A] | [μV · s] | [V] |
| Comparative Example 11 | Fe₂₀Ni₈₀ | fcc only | 0.82 | 1.00 | 0.98 | 2 |
| Comparative Example 12 | Fe₈₀Ni₂₀ | bcc only | 0.40 | 1.20 | 0.59 | 8 |
| Comparative Example 13 | Fe_{41.9}Ni₂₄Co₃₀Si₃Cr₁P_{0.1} | fcc only | 0.69 | 1.55 | 1.07 | 2 |
| Example 11 | Fe_{41.9}Ni₂₄Co₃₀Si₃Cr₁P_{0.1} | 0.20 | 0.81 | 1.73 | 1.40 | 22 |
| Example 12 | Fe_{41.9}Ni₂₄Co₃₀Si₃Cr₁P_{0.1} | 0.50 | 0.68 | 2.31 | 1.57 | 35 |
| Example 13 | Fe_{41.9}Ni₂₄Co₃₀Si₃Cr₁P_{0.1} | 0.50 | 0.80 | 1.75 | 1.40 | 30 |
| Example 14 | Fe_{41.9}Ni₂₄Co₃₀Si₃Cr₁P_{0.1} | 0.29 | 0.74 | 1.93 | 1.43 | 25 |
| Example 15 | Fe_{41.9}Ni₂₄Co₃₀Si₃Cr₁P_{0.1} | 0.30 | 0.68 | 2.30 | 1.56 | 35 |
| Example 12 | Fe_{41.9}Ni₂₄Co₃₀Si₃Cr₁P_{0.1} | 0.50 | 0.68 | 2.31 | 1.57 | 35 |
| Example 16 | Fe_{41.9}Ni₂₄Co₃₀Si₃Cr₁P_{0.1} | 0.80 | 0.67 | 2.30 | 1.54 | 36 |
| Example 17 | Fe_{41.9}Ni₂₄Co₃₀Si₃Cr₁P_{0.1} | 0.81 | 0.62 | 2.10 | 1.30 | 15 |
| Comparative Example 14 | Fe_{93.5}Si_{6.5} | bcc only | 0.60 | 1.80 | 1.08 | 4 |
| Example 18 | Fe_{93.5}Si_{6.5} | bcc only | 0.69 | 2.40 | 1.66 | 18 |
| Example 19 | Fe_{93.5}Si_{6.5} | bcc only | 0.81 | 2.25 | 1.82 | 17 |
| Example 20 | Fe_{93.5}Si_{6.5} | bcc only | 0.76 | 2.39 | 1.82 | 18 |

According to Table 2, the multilayer inductors of Examples 11 to 20, in which the soft magnetic metal particles each including the fcc phase and the bcc phase were included in at least one of the regions, had good characteristics.

Examples 11 to 16, in which all regions of the multilayer inductors included the soft magnetic metal particles each including the fcc phase and the bcc phase and having a bcc/fcc ratio of 0.01 or more and 0.80 or less, had a relatively good withstand voltage. In particular, Examples 12, 15, and 16, in which all regions of the multilayer inductors included the soft magnetic metal particles having a bcc/fcc ratio of 0.30 or more and 0.80 or less, had good characteristics.

Example 13 was the same as Example 11 except that the bcc/fcc ratio of the remaining region 4a was increased from that of Example 11. Increasing the bcc/fcc ratio of the remaining region 4a to 0.30 or more and 0.80 or less from that of Example 11 allowed the withstand voltage of Example 13 to increase while the inductance and the DC superimposition characteristics were maintained at about the same levels as those of Example 11.

Examples 18 to 20, in which only the coil inner-diameter region 4b and the cover regions 4c (top and bottom) substantially included the soft magnetic metal particles each including the fcc phase and the bcc phase and having a bcc/fcc ratio of 0.01 or more and 0.80 or less, had a relatively high L×Isat value. In particular, Examples 19 and 20, in which the bcc/fcc ratio was 0.01 or more and 0.40 or less, had a high L×Isat value.

In contrast, Comparative Examples 11 to 13, in which the soft magnetic metal particles each including the fcc phase and the bcc phase were not included, were under the same conditions as Comparative Examples 1 to 3, except that the average particle sizes of the soft magnetic metal particles in the coil inner-diameter region 4b and the cover regions 4c (top and bottom) were changed. However, the Isat values of Comparative Examples 11 to 13 did not change, and various characteristics thereof were not good.

Comparative Example 14 was under the same conditions as Examples 18 to 20, except that the soft magnetic metal particles each of which did not include the fcc phase and the bcc phase were used. However, Comparative Example 14 had all worse characteristics than Examples 18 to 20.

### NUMERICAL REFERENCES

1 . . . multilayer inductor
2 . . . element
2a . . . surface region
2b . . . center region
3 . . . terminal electrode
4 . . . magnetic element body
4a . . . remaining region
4b . . . coil inner-diameter region
4c . . . cover region
5 . . . coil conductor
5a, 5b . . . leading electrode
21 . . . water atomization apparatus
22 . . . tundish
23 . . . atomizing nozzle
25 . . . molten metal
27 . . . high-pressure water
29 . . . atomized powder

What is claimed is:

1. A soft magnetic metal particle comprising an Fe—Ni based soft magnetic metal, wherein the soft magnetic metal particle includes both an fcc phase and a bcc phase.

2. The soft magnetic metal particle according to claim 1, wherein a value calculated by dividing a diffraction peak intensity of the bcc phase in an X-ray diffraction chart by a diffraction peak intensity of the fcc phase therein is 0.01 or more and 0.80 or less.

3. The soft magnetic metal particle according to claim 1, wherein the soft magnetic metal particle comprises Fe, Ni, and Co as a main component.

4. A soft magnetic metal powder comprising the soft magnetic metal particle according to claim 1.

5. A magnetic element body comprising the soft magnetic metal particle according to claim 1.

6. A coil-type electronic component comprising the magnetic element body according to claim 5 and a coil conductor.

7. The coil-type electronic component according to claim 6, wherein the coil conductor is disposed inside the magnetic element body.

8. The coil-type electronic component according to claim 7, wherein a coil inner-diameter region and a cover region of the magnetic element body comprise the soft magnetic metal particle.
